(19) United States
(12) Patent Application Publication
(10) Pub. No.: US 2023/0056528 A1
(43) Pub. Date: Feb. 23, 2023

(54) SYSTEMS AND METHODS FOR FORMING AND UTILIZING PATTERNED FORMING & SEALING FILMS

(71) Applicant: Boar's Head Provisions Co., Inc., Sarasota, FL (US)

(72) Inventors: MICHAEL FIZER, Sarasota, FL (US); Joshua K. SMITH, Sarasota, FL (US); Kevin KAPOUN, Sarasota, FL (US); Jeremiah STEVENS, Sarasota, FL (US); James J. OLSON, Sarasota, FL (US)

(21) Appl. No.: 17/893,800

(22) Filed: Aug. 23, 2022

Related U.S. Application Data
(60) Provisional application No. 63/235,899, filed on Aug. 23, 2021.

(51) Int. Cl. A23P 30/10; A23L 13/00; A23L 5/10

(52) U.S. Cl. CPC A23P 30/10; A23L 13/00; A23L 5/10; A23V 2002/00; B29C 59/02

(57) ABSTRACT

Disclosed herein is a method for allowing forming & sealing films to be embossed/debossed with various shapes such as geometric, organic, or fractal and/or combination and various dimensions and depths. The texture or pattern is transferred to the film from an insert. The pattern on the forming & sealing film is then transferred onto the surface of the various proteins including but not limited to chicken, turkey, beef, pork, and plant proteins during the form-fill-seal and cook process. The forming and/or sealing inserts can form various thermoforming films with functional and/or decorative embossing and/or debossing without the use of knitted, elastic, extruded, tightly weaved, plastic netting, and/or compression forming molds and/or release agents for netting removal. Since the forming inserts are constructed using additive manufacturing processes, almost any design can be embossed/debossed onto the forming & sealing film.

### CROSS-REFERENCE TO RELATED APPLICATIONS

This application claims priority to U.S. Provisional Patent Application Ser. No. 63/235,899, filed Aug. 23, 2021, the entire contents of which are hereby incorporated by reference in their entirety.

### BACKGROUND

It is often desirable to imprint meat with a surface pattern for display, texture, and its ability to hold specific spices or flavorings. Product texture is also added by encasing the protein in a net during cooking, forming an imprint on the surface. However, this process is wasteful because the net is discarded after the cooking process. Therefore, a need exists for a forming & sealing film capable of directly imprinting a pattern onto protein without the need for extra material, such as a net.

### SUMMARY

The present invention allows forming & sealing films to be embossed/debossed with various shapes such as geometric, organic, or fractal and/or combination and various dimensions and depths. The texture or pattern is transferred to the film from an insert. The pattern on the forming & sealing film is then transferred onto the surface of the various proteins including but not limited to chicken, turkey, beef, pork, and plant proteins during the form-fill-seal and cook process. The forming and/or sealing inserts can form various thermoforming films with functional and/or decorative embossing and/or debossing without the use of knitted, elastic, extruded, tightly weaved, plastic netting, and/or compression forming molds and/or release agents for netting removal. Since the forming inserts are constructed using additive manufacturing processes, almost any design can be embossed/debossed onto the forming & sealing film.

### BRIEF DESCRIPTIONS OF THE DRAWINGS

The accompanying drawings, which are incorporated herein and form part of the specification, illustrate one or more aspects of the present invention and, together with the description, further serve to explain the principles of the invention and to enable a person skilled in the relevant art(s) to make and use the invention.

FIG. 1 depicts an embossed film having a raised impression on the inside of the formed film.

FIG. 2 depicts the debossed depression transferred to the protein during cooking.

FIG. 3 depicts the lower impression on the inside of the formed film.

FIG. 4 depicts the embossed depression transferred to the protein during cooking.

FIGS. 5A-5E depict examples of patterns applied to formed films.

FIG. 6 depicts a flowchart showing the steps used in a standard encasing and cooking process.

FIG. 7 depicts a flowchart showing the steps used in the encasing and cooking process according to the present invention.

FIG. 8-10 depict an embodiment of a forming insert.

FIGS. 11-12 depict another embodiment of a forming insert.

FIG. 13 depicts a formed film removed from a forming insert.

FIG. 14 depicts an example of a cooked protein after removal of the formed film.

The features and advantages of the disclosed embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. Unless otherwise indicated, the drawings provided throughout the disclosure should not necessarily be interpreted as to-scale drawings.

### DETAILED DESCRIPTION

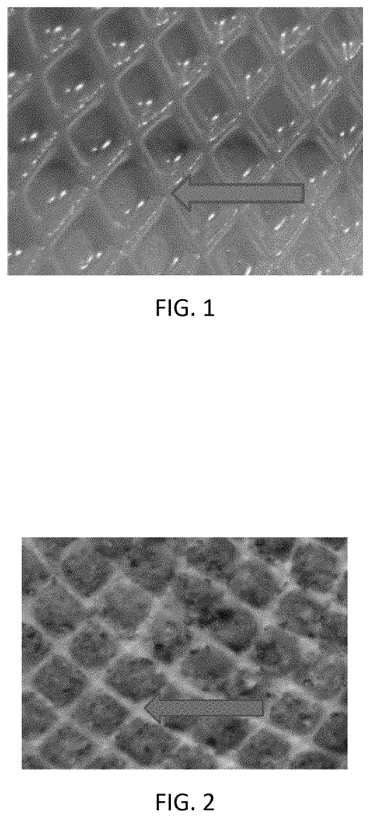

All standard form-fill-seal cook-in processes incorporate primary forming. Typically, the primary forming process only includes a single film forming process. In contrast, the method of the present invention incorporates a primary and a secondary film forming process. A primary forming process creates an embossed film having a raised impression on the inside of the formed film as depicted in FIG. 1.

The primary film forming process preferably is used to simulate functional and decorative netting impressions that will transfer into the surface of the protein during the cooking process. The primary thermoformed embossed impression transfers into the surface of the protein during cooking, becoming the debossed or lower depression on the protein as depicted in FIG. 2.

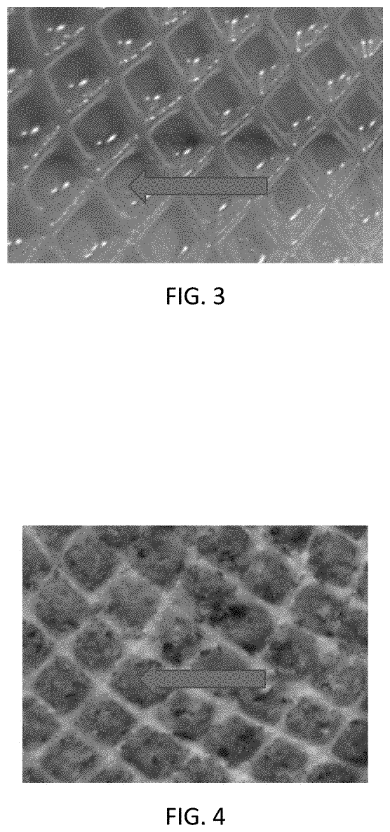

The secondary forming process is the lower debossed depression on the inside of the formed pocket. The secondary thermoformed shape is produced from residual forming film materials derived from the “Primary” thermoforming process. This depression simulates functional and decorative patterns that will transfer into the surface of the protein during the cooking process (FIG. 3).

The Secondary thermoformed debossed depression will transfer on the surface of the protein becoming the embossed or raised impression (FIG. 4).

The forming & sealing films are formed using the following process. First, the film is unrolled across the forming insert. The forming film is heated in a controlled manner to make the film pliable and subject to impression. A controlled high-pressure air is then used to force the films into the forming inserts. This causes the forming films to take the shape of the forming insert. The protein to be sealed is then placed into the forming insert over the forming film.

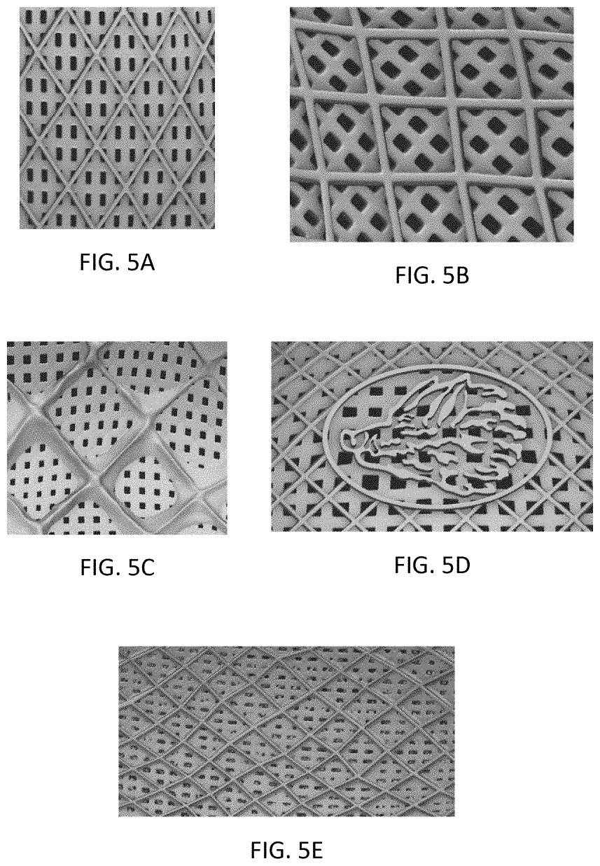

As depicted in FIGS. 5A-5E, any pattern can be formed on the forming inserts and then transferred to the forming & sealing film. Different patterns may include, but are not limited to:
Net or netting pattern—Transferred from the forming insert to the film to the protein (FIGS. 5A-5E)
Logo—Company logo, watermark, brand mark, text, or 2D/3D layers into the protein (FIG. 5D).
Patterns made to mimic natural occurrences in other cooking styles (e.g. “searing”, “wrapping”, “grilling”, etc.) (FIG. 5C & 5E)
Intentional defects to distinguish the realistic and natural occurrences of the product.
   The forming films may be any desired shape capable of encasing the protein (e.g. ham shaped like a football, chicken shaped eggs for Easter etc.) Different patterns may also be formed from a combination of styles such as geometric, organic, fractal, square, rectangle, diamond, hexagon, scaled, branching, waves, etc.).

### Sealing Process

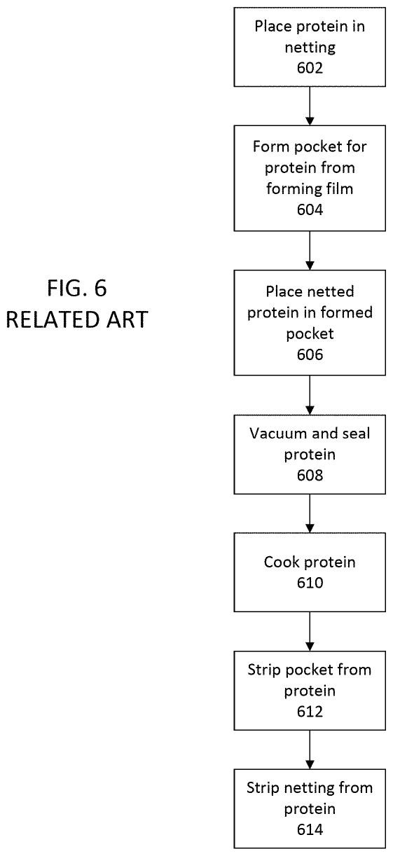

FIG. 6 depicts a flowchart showing the standard process used for encasing and cooking the protein. First, the desired netting is placed around the protein in step 602. This step is typically labor intensive as it requires human personnel to place the protein in the netting and seal it. A rollstock packaging machine is then used to form the forming & sealing film into a pocket in step 604. Specifically, the forming film is placed into a forming-shaped cavity to form the pocket and thermal forming is used to form the forming film into the desired shape.

The netted protein is placed in the formed pocket in step 606. The pocket is sealed and vacuumed in step 608 to create an airtight encasement for the protein. The pressure caused by the vacuum against the netting caused the netting pattern to transfer to the protein during cooking in step 610.

After the protein has been cooked, the pocket is first removed in step 612 and the netting is removed in step 614. While it is possible automate the removal of the pocket in step 612, removal of the netting in step 614 requires human personnel.

The process of the present invention eliminates many of the steps requiring human intervention and netting, allowing for a large reduction in waste and human intervention to be achieved. As already described, the method of the present invention uses a forming & sealing film having a netting pattern which is directly transferred to the protein during cooking. This eliminates the need for steps 602 and 614 in which the netting must be added and removed by human personnel.

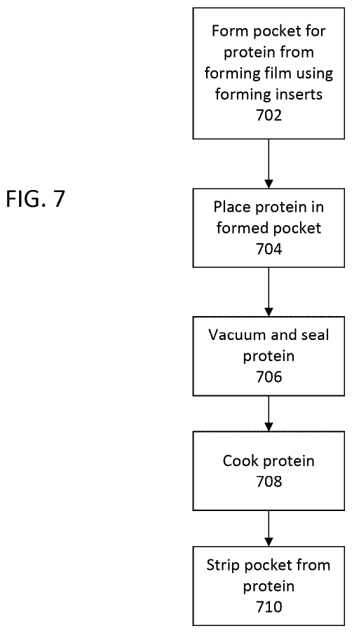

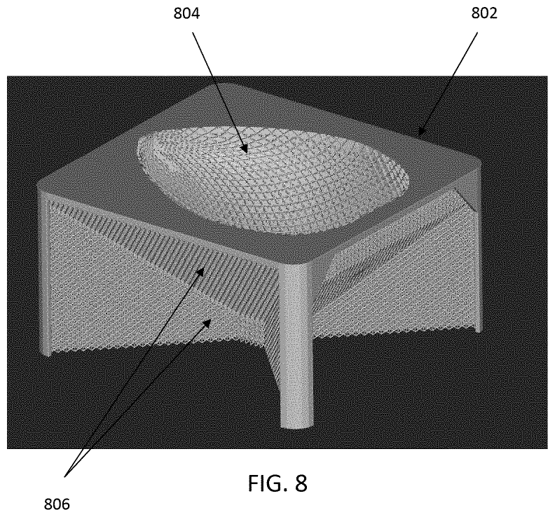

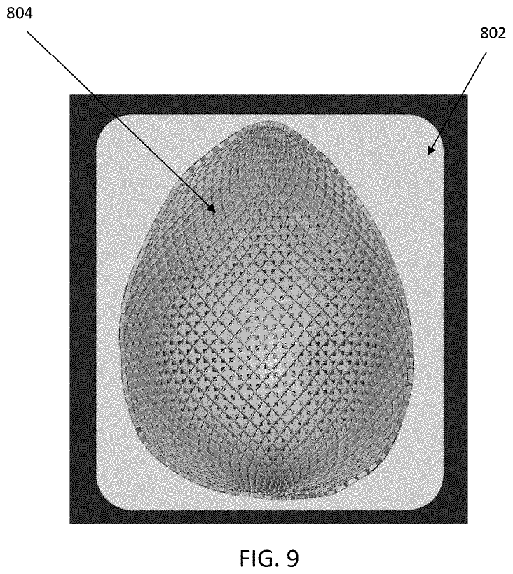

FIG. 7 depicts a flowchart showing the steps used in the encasing and cooking process according to the present invention. First, the forming & sealing film is placed into the forming inserts to form the pocket for the protein in step 702. A perspective view of a forming insert 802 is depicted in FIG. 8 and a top view of the forming insert 802 is depicted in FIG. 9. As shown, the forming insert 802 comprises a top section having a forming cavity 804. The forming & sealing film is placed over this cavity 804 and rapid air forming is used to cause the forming & sealing film to confirm to this pattern. The sides of the forming insert 802 comprise a plurality of ventilation structures 806 to allow the air to be evacuated. The sides also provide structural support for the forming insert 802.

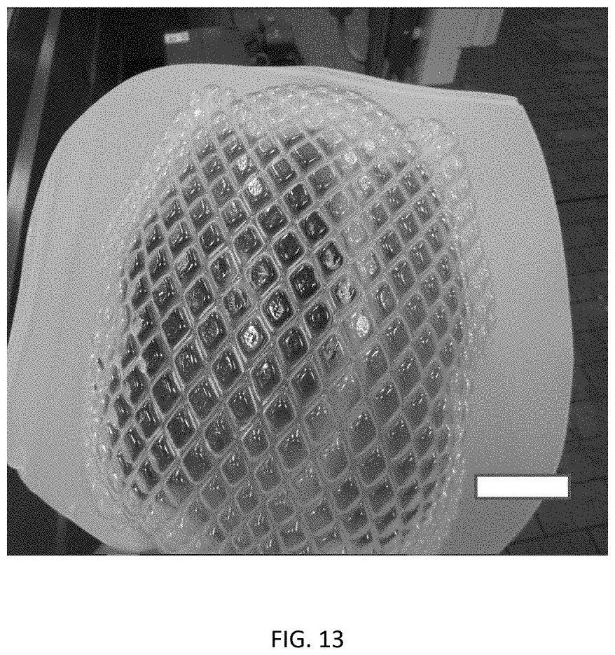

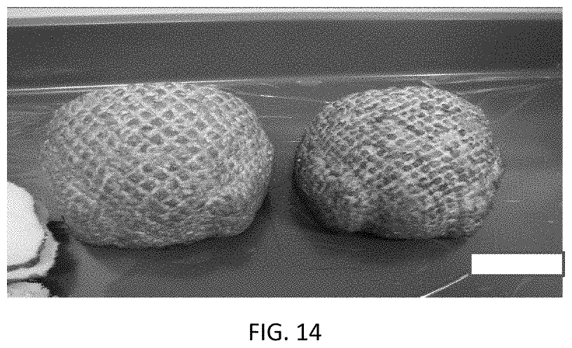

A formed sealing film removed from forming insert 802 is depicted in FIG. 13. As shown, the netting pattern from the forming insert 802 is transferred directly to the formed film. In turn, the 3D pattern on the formed sealing film is transferred to the protein during the cooking process (FIG. 14), obviating any need for netting to be applied or removed from the protein.

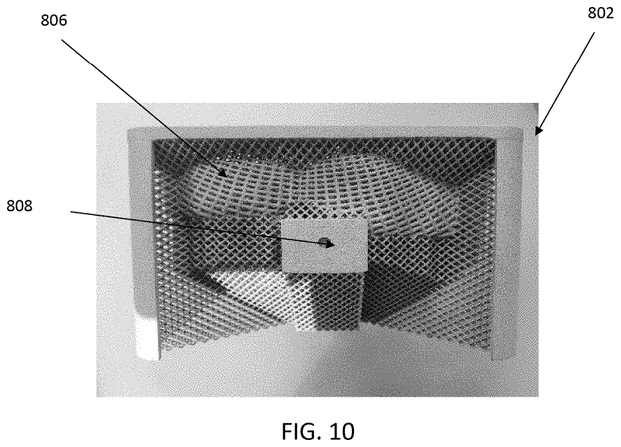

The forming insert 802 may be coupled to the rollstock using an anchor 808 depicted in FIG. 10. The forming inserts 802 are placed into the sealing boxes of the rollstock and anchored to ensure a proper fit with no movement during the film molding process. Anchoring can be accomplished in several ways including:
Slots, latching, bolts, or any other securing functions
Insert is locked into the forming or sealing box from any single side or multiple sides, from the bottom, and/or from the top.

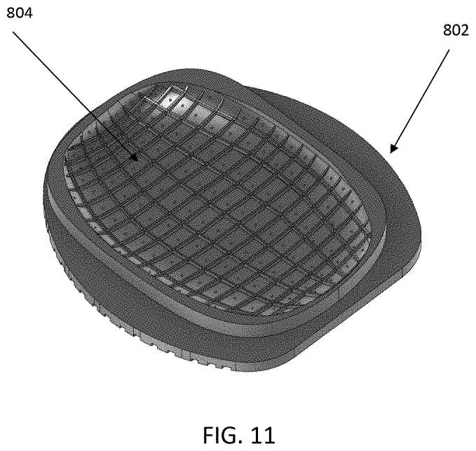

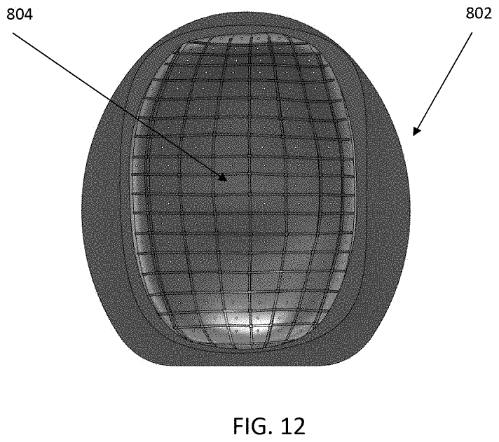

After the top and bottom forming inserts 802 are used to form the pocket, the protein is placed in the formed pocket in step 706. The pocket is sealed and vacuumed in step 706 to create an airtight encasement for the protein. The 3D pattern on the forming & sealing film is transferred to the protein during cooking in step 708. After the protein has been cooked, the pocket is first removed in step 710. No netting is needed to add the impression to the protein since it is directly transferred from the forming & sealing film. An additional example of a sealing insert with a different pattern is depicted in FIGS. 11 (perspective) and 12 (top view).

### Forming & Sealing Films

The process described in FIG. 7 is compatible with a variety of films depending on the size of the cavity and required final shape and impressions. Some shapes require variations such as thinner or thicker films, films with a tacky inner face or to be more porous, or for the film to be pre-shrunk to a varying degree. Film combinations between the sealing requirements are also possible. By way of example, the following film types are compatible:

Polyethylene

Polypropylene

Nylon

Ethylene-vinyl alcohol copolymer

Barrier films

Layered combinations of films

The forming & sealing films should be usable over a wide variety of temperature ranges: forming design temp range 90° C.-145° C. and sealing temp range 130° C.-160° C. The physical forming of the forming & sealing film using insert using forming insert 802 may be accomplished using any known methods including plug assist, forced air, forced Air w/vacuum assist, tiered temperature-controlled zones, High pressure rapid air forming, or explosive forming vacuum.

### Forming Inserts

The following materials may be utilized for additive manufacturing and creation of the sealing inserts 802:
Metal (aluminum, Inconel, steel, titanium, or other nickel-based alloys)
   Form may be created through deposition, sintering, or other forms of melting and fusion.
   Meet product dimension specifications up to 400×400×400 millimeters.
   Material must be able to withstand final finishing including wire EDM, drilling, cutting, electropolishing and coating.
   Final build must withstand pressures of 100-200 psi and temperatures of 150-200° Celsius.
   Surface treatments may be required including Electroless Nickel with

Polytetrafluoroethylene, nickel polish or nickel-PTFE
Resin
   Resins are selected based on their tensile strength and modulus, flexural modulus, impact strength, elongation, and heat deflection temperature.
   May be used in the creation, prototyping, and/or testing phase.
   Form could be generated through Stereolithography (SLA), Digital Light Processing (DLP), or Selective Laser Sintering (SLS)
   Final build must withstand pressures of 100-200 psi and temperatures of 150-200° Celsius through the testing phase.
Plastic (ABS, PLA, PETG, Nylon)
   Used in the early prototyping and testing phases as a low-cost alternative to testing the viability of the form shape.
   Final build must withstand pressures of 100-200 psi and temperatures of 150-200° Celsius through the testing phase.

As already described, virtually any pattern can be developed forming inserts 802. This can create a design that reduces the amount of metal, and generates required ventilation and shape. The size of the air flow ventilation structures 806 and the primary and secondary forms have not been used in thermoforming processes before. The airflow/support structure design lattice (See FIGS. 8 & 10) allows the control of both temperature and air flow of the film through the emboss/deboss of the film into small areas of the forming insert 802 shape to meet the requirements of the forming & sealing film that is chosen.

Variable corner and edge design for ventilation (this allows for pressure variation to form deeper impression pockets into the primary and secondary form) previously could not easily be made using other methods. These variable primary and secondary variable corner ventilation can range in size to minimize or maximize air flow. By adjusting the size of the ventilation on the primary and secondary forming inserts 802, the embossing and debossing can be controlled unlike with netting.

As depicted in FIG. 8, for example, each forming insert has a plurality of ventilation structures whereas current forming inserts (for use with FIG. 6) use a solid material. Increased ventilation in forming inserts 802 eliminates the need for liquid cooling the forming box in step 604. The forming inserts 802a1so integrate more than one function into a physical part (sealing and pattern transfer).

The Brim/Legs support structure on the forming inserts 802 allow support and the minimum material that would be needed for lattice structure, ventilation, and support. It provides the necessary strength in order to resist the internal forces during forming and guides the forming insert 802 into the forming box that is held into via the anchor mechanism 808.

The entire profile of the forming inserts 802 and the multiple levels of impression for film and film adhesion results may vary based on control and different criteria. The goal is to establish conditions to stabilize the individual “Primary Thermoformed” and “Secondary Thermoformed” cells in order to retain much of the original cell volume when exposed to thermal processing in the product cook cycle, as well as establish conditions that generates “Controlled Shrink” to the “Primary Thermoformed” cavity shape 804 in order to provide adequate package shrink force to ensure the cell pattern of the secondary forming transfers to the product during the cook cycle. The following is a list of criteria that assist in the forming process that helps with controlling the shrink of the film:

Selection of thermoforming material.

Stability of thermoforming temperature.

Controlled temperature of thermoforming tooling.

Forming air pressure and forming time.

Cooling time once forming has taken place.

### Generating Forming Inserts

Additive manufacturing requires software to generate the forming inserts 802, including options for converting a form to digital through 3D scanning, designing the form through CAD software, and controlling the machines for fabrication of the sealing inserts for use with the present invention.
1. 3D scanning reference objects—Scanning software used to scan and view the control pieces to start the entire project may be employed. This can be used for any object or shape we the user wants to scan and turn into a mold.
2. CAD Software—Build smooth topology mesh over the reference model scan from step 1, or used to make a new model, and generate the positive form object.
   a. Continue to create a base pattern mesh on top of smooth retopology mesh (so you have two meshes)
   b. Continue to make three copies of base pattern mesh
      i. Backup copy mesh
      ii. Filled-in copy mesh
      iii. Use bevel tool to create net pattern extrusion mesh
3. Secondary CAD Software—Use base pattern meshes to generate net patterns, backing patterns, and support material
   a. Combine all pieces into one model
   b. If viable, build frame and securing block if final output is for 3D printing in metal.
   c. Cleanup, retopologizing, filling holes, reducing face count for easier exporting to printer.
   d. Include all latticed ventilated model including all steps from 2a-2b
   e. Export mesh (entire mold design)
4. Slicer/Build Preparation Software—Import final mesh for verification of entire mold, establishing the part orientation, support structures, layer thickness, timing, and other paths and settings as determined by the geometry of the form.
   a. Build preparation software will generate an .STL or native file that the 3D printing machine will use as instructions to product the final, usable piece.

It will be understood that the embodiments described above are illustrative of some of the applications of the principles of the present subject matter. Numerous modifications may be made by those skilled in the art without departing from the spirit and scope of the claimed subject matter, including those combinations of features that are individually disclosed or claimed herein. For these reasons, the scope hereof is not limited to the above description but is as set forth in the following claims, and it is understood that claims may be directed to the features hereof, including as combinations of features that are individually disclosed or claimed herein.

1. A method for forming and utilizing a patterned sealing film comprising:
placing a forming & sealing film on an upper forming insert,
wherein the upper forming insert comprises a central cavity with a three-dimensional embossing pattern;
forming an upper film from the forming & sealing film using the upper forming insert;
forming a lower film;
combining the upper film and the lower film to form a film pocket;
inserting protein into the film pocket;
vacuuming and sealing the protein in the film pocket;
cooking the protein in the film pocket,
wherein the three-dimensional embossing pattern is transferred to the protein during cooking; and
removing the film pocket after the protein is cooked.

2. The method of claim 1, wherein the upper film and the lower film are formed from high pressure rapid air forming.

3. The method of claim 2, wherein the three-dimensional embossing pattern is transferred to the upper film during forming.

4. The method of claim 1, wherein the three-dimensional embossing pattern comprises a plurality of raised areas and a plurality of depressed areas.

5. The method of claim 1, wherein the three-dimensional embossing pattern is a net pattern.

6. The method of claim 1, wherein the three-dimensional embossing pattern comprises a company logo or graphic.

7. The method of claim 1, wherein the upper forming insert is aluminum.

8. The method of claim 1, wherein the upper forming insert comprises:
a plurality of ventilation structures surrounding the cavity.

9. The method of claim 8, wherein the upper forming insert further comprises:
an anchor section for anchoring the upper forming insert to a forming box during forming of the upper film.

10. The method of claim 9, wherein forming of the upper film does not require liquid cooling of the forming box.

11. A method for forming a patterned sealing film comprising:
placing a forming & sealing film on a forming insert,
wherein the forming insert comprises:
a central cavity with a three-dimensional embossing pattern;
a plurality of ventilation structures surrounding the central cavity; and
an anchor section for anchoring the forming insert to a forming box during forming of the patterned sealing film; and
forming the patterned sealing film from the forming & sealing film using the forming insert,
wherein the three-dimensional embossing pattern is transferred to the forming film.

12. The method of claim 11, wherein the patterned sealing film is formed using high pressure rapid air forming.

13. The method of claim 11, wherein the forming insert is not liquid cooled.
